(19) United States
(12) Patent Application Publication
(10) Pub. No.: US 2026/0341193 A1
(43) Pub. Date: Oct. 29, 2026

(54) PERIPHERAL DISPLAY COLOR CALIBRATION VIA AMBIENT LIGHT SENSOR

(71) Applicant: Dell Products L.P., Round Rock, TX (US)

(72) Inventors: Ghee Beng Ooi, Singapore (SG); Chih Hao Kao, Singapore (SG); Jin Shiong Koh, Singapore (SG); Guentaek Oh, Singapore (SG)

(73) Assignee: Dell Products L.P., Round Rock, TX (US)

(21) Appl. No.: 19/186,767

(22) Filed: Apr. 23, 2025

(51) Int. Cl. G09G 3/20; G01J 1/42

(52) U.S. Cl. CPC G09G 3/2096; G01J 1/4204; G09G 2320/0233; G09G 2320/0242; G09G 2320/043; G09G 2320/0693; G09G 2354/00; G09G 2360/144; G09G 2360/16

(57) ABSTRACT

A calibration member couples to a display to align a light guide material between the display panel and an ambient light sensor that detects the color temperature and brightness of the display panel visual image. A processing resource of a scaler of the display interfaced with the ambient light sensor compares the detected color temperature and brightness of the display panel against an expected value to adjust the display visual image presentation settings so that the display panel presentation of visual images is calibrated to the settings of the display.

### BACKGROUND OF THE INVENTION

### Field of the Invention

The present invention relates in general to the field of information handling system displays, and more particularly to an information handling system display color calibration by ambient light sensor.

### DESCRIPTION OF THE RELATED ART

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems process information with a processor and memory coupled in a housing that cooperate to execute instructions. Stationary information handling systems interface with an end user through peripheral devices, such as a peripheral keyboard, peripheral mouse and peripheral display. Portable information handling systems integrate processing components, a display, a keyboard and a power source in a portable housing to support mobile operations. Portable information handling systems allow end users to carry a system between meetings, during travel, and between home and office locations so that an end user has access to processing capabilities while mobile. Portable information handling systems will also typically interface with peripheral devices to interact with an end user, such as through a dock.

Peripheral displays typically present visual images with an array of pixels that each illuminate with a color so that a composite of the array of pixels defines the visual image. Liquid crystal displays passes the backlight through liquid crystal material that changes the amount of light that passes through based on an electrical field applied to the liquid crystal material. For instance, each pixel's liquid crystal material is controlled by a timing controller so that the composite light passing through the pixel exhibits its desired lighting, which then passes through a color filter material to exhibit a combination of red, blue and green colors. The brightness of the display image depends upon the amount of backlight and the amount of light blocked by the liquid crystal material. As the backlight is used over time, the amount of light and quality of white light provided from the backlight can change. Organic light emitting diode (OLED) displays generate illumination by applying an electric field to an organic material that emits light in response. OLED display pixels generate colors with different amounts of light generated at each pixel from red, green and blue organic material. The brightness of each pixel is controlled by changing the amount of current applied to each color of organic material. OLED material tends to deteriorate over time so that the amount of light for a given current tends to decrease as the display is used.

One difficulty with presentation of visual images at a display is that the light seen by an end user will vary based upon ambient light conditions. Displays typically include an ambient light sensor to adjust display brightness as ambient brightness changes so that images remain viewable in bright and dim light conditions. More recently, displays include ambient light sensors that include color detection so that the color temperature of visual images may be adjusted based on ambient light conditions. Adjusting color temperature based on ambient light color conditions aids in eye comfort when viewing images by keeping a desired mix of red, green and blue light. Although ambient light color sensing can improve an end user experience by more precisely calibrating visual images to a desired color temperature, these adjustments lose their precision over time as usage of the display changes the colors presented by the display.

### SUMMARY OF THE INVENTION

Therefore, a need has arisen for a system and method which calibrates a display panel to present visual images at a desired illumination, such as a calibrated brightness and color temperature.

In accordance with the present invention, a system and method are provided which substantially reduce the disadvantages and problems associated with previous methods and systems for calibration of a display panel. A calibration member couples to the display with one end at a front face of the display panel and the other end at an ambient light sensor included in the display so that light is directed from the display panel to the ambient light sensor for measurement of the display illumination brightness and color temperature. The ambient light sensor measurements are provided to the display scaler, which compares the measure values against expected values and adjusts the display settings to achieve the expected values.

More specifically, an information handling system processes information by executing instructions in cooperation with a memory that stores the instructions and information. The processor interfaces with a display, such as through a graphics processor, to present the information as visual images, such as by defining pixel values that assign colors to an array of pixels. A scaler of the display manages visual image presentation through an on-screen display menu that accepts visual image presentation settings, such as brightness and color temperature. The display includes one or more ambient light sensors that detect ambient light so that the scaler can adjust the visual images to have a neutral presentation in various ambient light conditions. A calibration member fits over the ambient light sensor at one end and against a display panel at an opposite end so that light from the display panel is directed to the ambient light sensor. The scaler applies the ambient light sensor measurements to compare the display panel visual image presentation illumination brightness and color temperature against expected values based upon illumination color and brightness assigned to the display panel. Differences between the expected and actual illumination are applied by the scaler so that the display panel illumination matches the display panel settings.

The present invention provides a number of important technical advantages. One example of an important technical advantage is that a display panel illumination, such as brightness and color temperature, is calibrated to achieve settings of the display panel by the display scaler. Calibration of the display panel illumination maintains a consistent visual image presentation over time, such as with periodic calibrations, to compensate for changes in the character of the display panel due to usage and other factors. The calibration is performed with an ambient light sensor included in the display panel by re-directing illumination from the display panel to the ambient light sensor. Calibration may be automatically initiated and terminated based upon illumination sensed at the ambient light sensor, such as with a comparison between different ambient light sensed values by different ambient light sensors of the display or by detecting ambient light that matches the display panel illumination or that is dark indicating that the ambient light sensor is covered by the calibration member and placed against a rear side of the display.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an information handling system interfaced with a display having a calibration member to calibrate display illumination;

FIGS. 2A, 2B and 2C depict the calibration member in storage, in use and separate from the display;

FIGS. 3A, 3B and 3C depict the ambient light sensor and calibration member in various arrangements;

FIG. 4 depicts a side sectional view of the calibration member illustrating communication of illumination from the display panel to the ambient light sensor of the display;

FIG. 5 depicts a flow diagram of a process for calibration of display panel illumination based on sensed illumination;

FIG. 6 depicts a block diagram of a display scaler configured to calibrate display panel illumination; and

FIG. 7 depicts a flow diagram of a process for calibrating color values at a display panel.

### DETAILED DESCRIPTION

An information handling system display calibration member directs display panel illumination to an ambient light sensor to calibrate display panel illumination. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

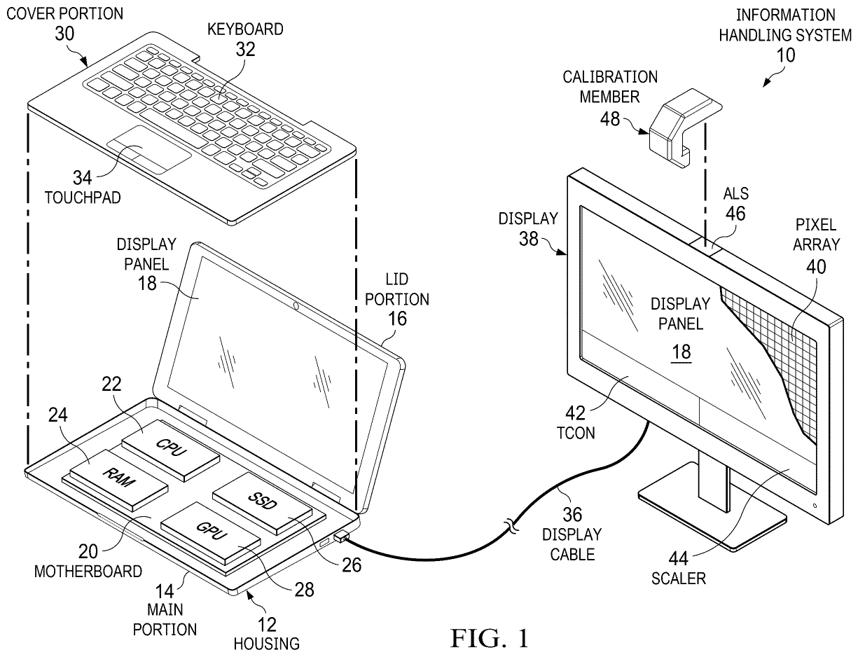

Referring now to FIG. 1, an information handling system 10 is depicted interfaced with a display 38 having a calibration member 48 to calibrate display illumination. In the example embodiment, information handling system 10 has a portable configuration with a portable housing 12 having a main portion 14 rotationally coupled to a lid portion 16. A display panel 18 couples in lid portion 16 to present information as visual images. A motherboard 20 couples in main portion 14 to interface processing components that cooperate to process information. For example, a central processing unit (CPU) 22 executes instructions to process information in cooperation with a random access memory (RAM) 24 that stores the instructions and information. A solid state drive (SSD) 26 stores instructions in non-transient memory, such as flash memory, that are retrieved at system power up, such as an operating system and applications. A graphics processing unit (GPU) 28 performs additional processing of information to generate visual images for presentation at a display, such as by defining the visual images with pixel values. A housing cover portion 30 couples over the housing main portion to enclose the processing components and support an integrated keyboard 32 and touchpad 34. In alternative examples, a stationary information handling system may be used with a fixed housing that interfaces to end users through a peripheral keyboard and mouse. Both stationary and portable information handling systems interface with peripheral display 38 through a display cable 36 that communicates pixel values from GPU 28, such as through a USB Type C or other cable.

Peripheral display 38 presents visual images at a pixel array 40 that defines the images as colors. A timing controller 42 scans the pixel values to the array of pixels under the management of a scaler 44 that includes a processing resource, such as a microcontroller unit (M CU), and non-transitory memory storing instructions. For example, scaler 44 presents an on-screen display menu (OSD) that provides an end user with access to display settings, such as video source, brightness, contrast, color temperature and other factors. Scaler 44 presents the visual images with end user preferences calibrated to achieve a desired visual effect. Each peripheral display may have variations in the presentation of visual images that are compensated by scaler 44, such as due to wear from display usage over time. When the peripheral display calibration varies from stored values, the end user may have visual images presented in an unexpected manner. To calibrate the display panel 18, a calibration member 48 fits against the front side of display panel 18 to redirect light from the display panel visual image presentation to an ambient light sensor (ALS) 46 included in the upper side of display 38. During normal operations, ambient light sensor 46 detects ambient light brightness and color so that scaler 44 can adjust the presented brightness and color in a manner that neutralizes the effects of ambient light. When calibration member 48 redirects display panel 18 illumination to ambient light sensor 46, scaler 44 detects the presented visual image brightness and color to compare against an expected value based upon the calibration setting. When a difference exists between the detected illumination of the visual images and an expected value, scaler 44 performs an adjustment to the calibration values to recalibrate the display visual image presentation.

Recalibration may be initiated by an end user through the OSD menu or may be automatically initiated when the scaler detects that the ambient light sensor sensed values fall within a predetermined range of presented values. Once recalibration is initiated, scaler 44 may exercise control over the visual images presented under the calibration member 48 so that a more precise display panel presentation is achieved. For instance, the display panel 18 may continue to present visual images provided from GPU 28 while scaler 44 writes calibration values into the frame buffer at the location of calibration member 48. The scaler values may include different colors that are then presented under the calibration member 48 and measured by ambient light sensor 46. For example, red, green and blue colors may each be calibrated in turn. Brightness may also be calibrated as a composite color or with each color presented in turn. When the brightness is calibrated with a liquid crystal display (LCD) panel, the entire display panel brightness may be adjusted to perform calibration of brightness. When an organic light emitting diode (OLED) display is used, calibration of brightness may be performed by adjusting illumination under calibration member 48 while the remainder of display panel 18 presents visual images. In one example embodiment, calibration is performed by changing the calibration setting until the light detected under the calibration member 48 matches the calibration illumination. Once calibration is complete, calibration member 48 is removed and placed in a storage position. In one embodiment, removal of calibration member 48 is detected by return to ambient light illumination and the calibration operation is terminated. In one example embodiment, the removal of the calibration member is detected by ambient light measurements of a separate ambient light sensor and ambient light sensor 46. In another example embodiment, ambient light sensor 46 detects darkness when calibration member 48 is placed in the storage position.

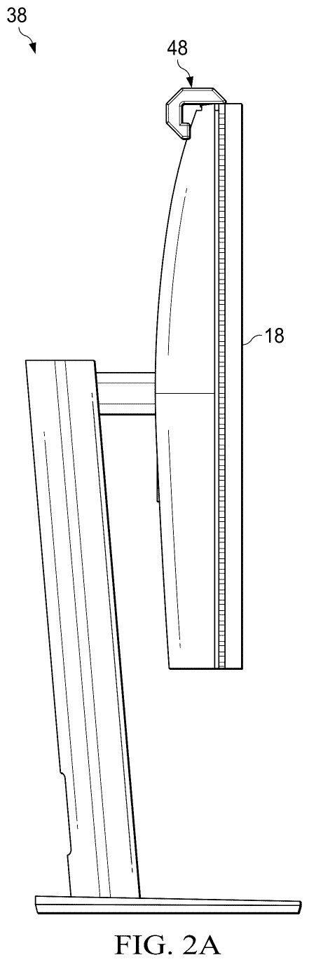

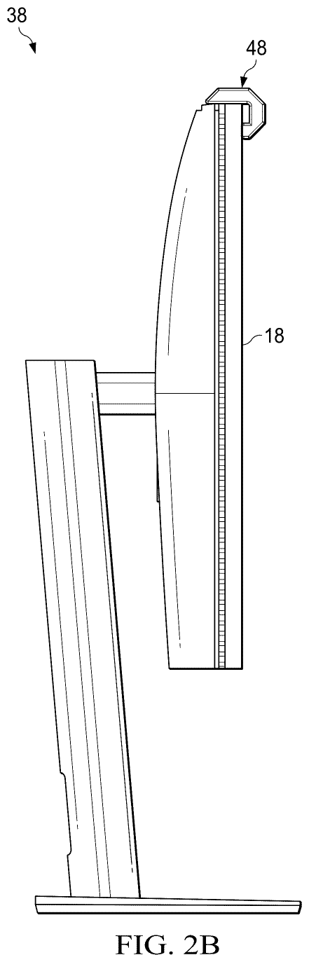

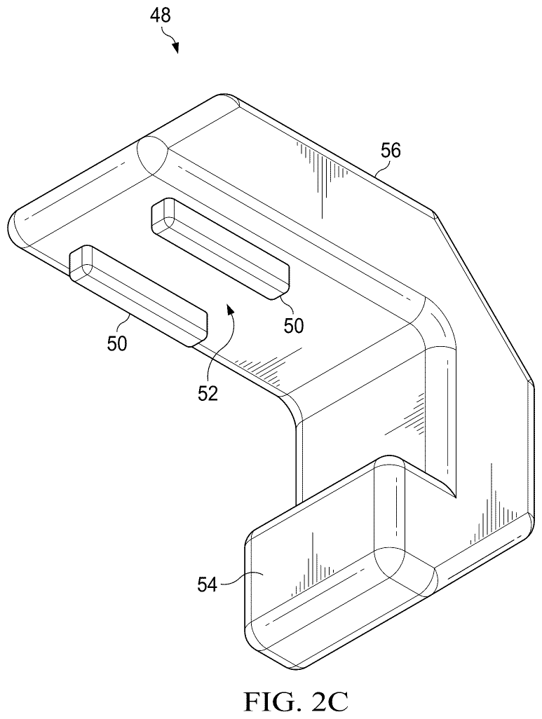

Referring now to FIGS. 2A, 2B and 2C, the calibration member 48 is depicted in storage, in use and separate from the display. FIG. 2A depicts calibration member 48 placed on display 38 in a storage position having one end against a rear side of the display and the other end over an ambient light sensor of the display. In the example embodiment, ambient illumination enters into calibration member 48 at a rear side of display 38 so that the ambient light illumination detected by the ambient light sensor may be measured and applied by the scaler. In one embodiment, such ambient light readings may be adjusted to account for variations related to light loss during passage through calibration member 48. For example, calibration member 48 includes an acrylic or similar light guide material and a reflective chamber to efficiently pass light, however, some light loss will occur. Alternatively, the storage position may block light passage as an indication that calibration member 48 is in a storage position. FIG. 2B depicts calibration member 48 in the calibration position with one end against display panel 18 and the other end over the display's ambient light sensor so that light is directed from the display panel to the ambient light sensor as described above. FIG. 2C depicts calibration member 48 separate from the display. Rib members 50 extend down from a body 56 at a window 52 to insert into grill openings of the display. In the orientation of FIG. 2A, a window 54 aligns against the rear side of display 38. In the orientation of FIG. 2B, window 54 aligns against display panel 18 to receive illumination from the display panel and guide the illumination to window 52 where the illumination exits at the display ambient light sensor as described above.

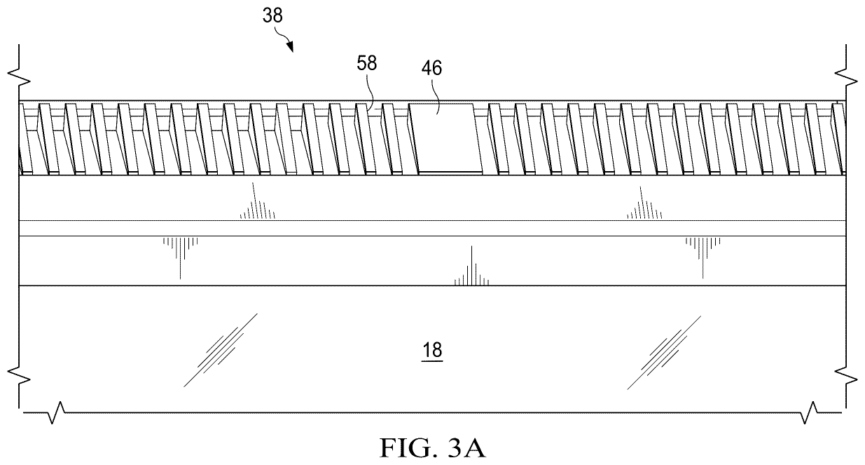

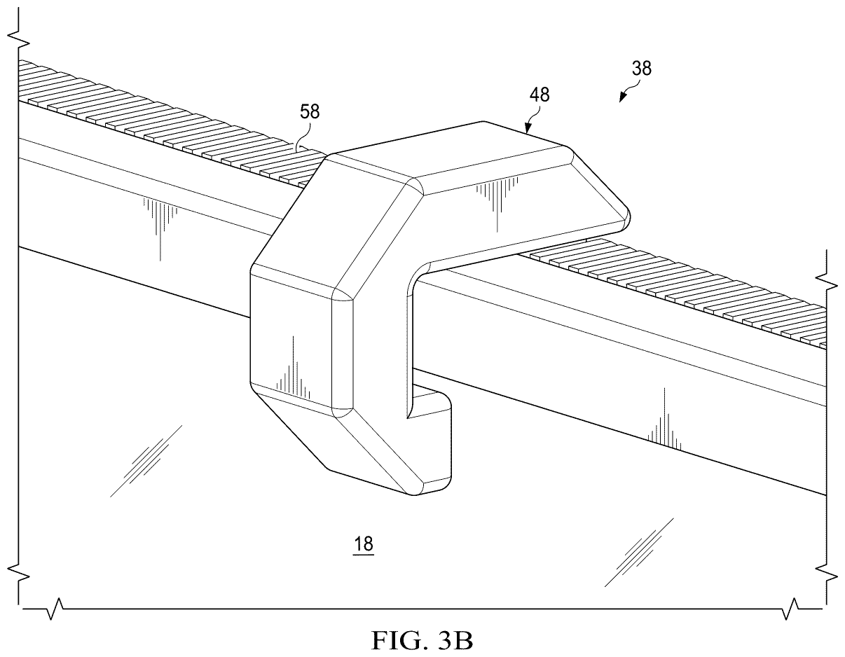

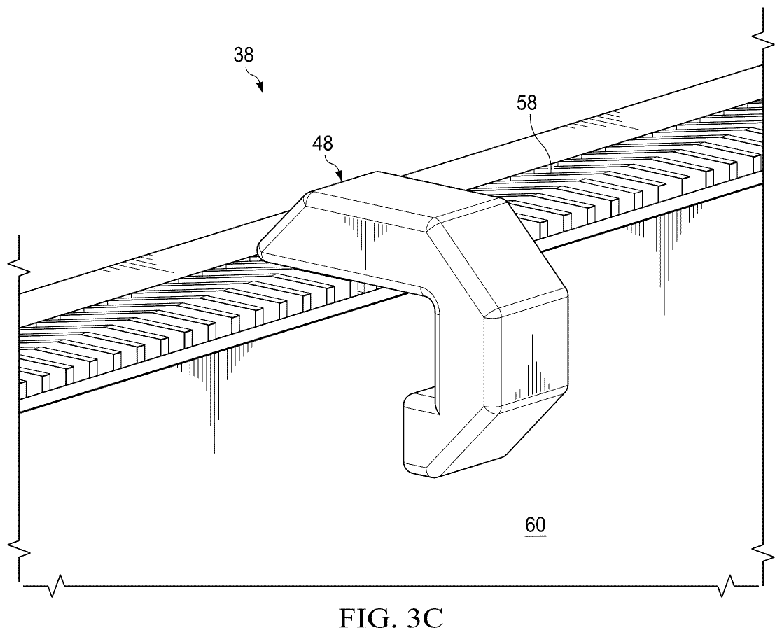

Referring now to FIGS. 3A, 3B and 3C, the ambient light sensor 46 and calibration member 48 are depicted in various arrangements. FIG. 3A depicts a detailed upper perspective view of display 38 showing a grill 58 on the top side of display 38 and having grill openings on each side of ambient light sensor 46 so that the calibration member may couple to display 38 with a window pressed against either display panel 18 or the rear side of display 38. FIG. 3B depicts a detailed front perspective view of calibration member 48 with its rib members inserted into grill 58 so that the window presses against the front side of display panel 18 to receive the illumination of the display panel and direct the illumination into the ambient light sensor. FIG. 3C depicts a detailed rear upper perspective view of calibration member 48 with its rib members inserted into grill 58 so that the window presses against a rear side 60 of display 38 to block illumination from passing through the calibration member 48 light material.

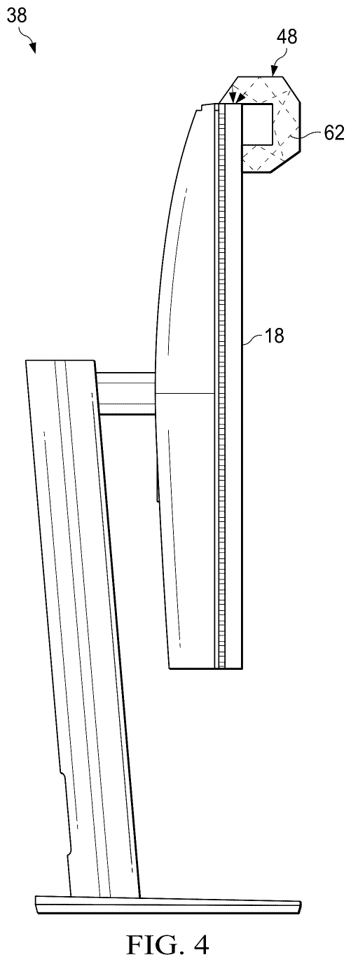

Referring now to FIG. 4, a side sectional view depicts the calibration member 48 illustrating communication of illumination from the display panel 18 to the ambient light sensor of the display. The sectional view illustrates light rays 62 that enter the first calibration member window from display panel 18 and reflect against internal mirrored surfaces of the calibration member to pass through a light guide material, such as acrylic, and into the ambient light sensor of the display. In the example embodiment, light loss related to passage through the calibration member may be taken into account by the scaler when calibrating the display panel.

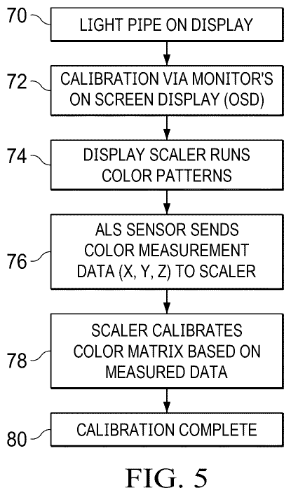

Referring now to FIG. 5, a flow diagram depicts a process for calibration of display panel illumination based on sensed illumination. At step 70 the calibration member is placed on the display to accept light from the display panel and act as a light pipe that directs display panel illumination from the display panel through the light pipe and to an ambient light sensor. At step 72 the calibration process is initiated by an end user selection through an OSD menu or, alternatively, in an automated manner when the illumination detected by the ambient light sensor matches illumination expected from the display panel or differs from ambient light detected by other ambient light sensors of the display. At step 74 the scaler presents predetermined color patterns that aid in the calibration process, such as by inserting the color patterns into the display frame buffer at the location of the calibration member window. At step 76 the ambient light sensor sends the color measurements in pixel array x, y and z data to the scaler. At step 78 the scaler calibrates the color matrix of the display panel based upon the ambient light sensor measure data. In various embodiments, the process may iterate to help ensure an accurate light calibration. At step 80 the calibration is completed and a message may be presented to the end user to remove the calibration member.

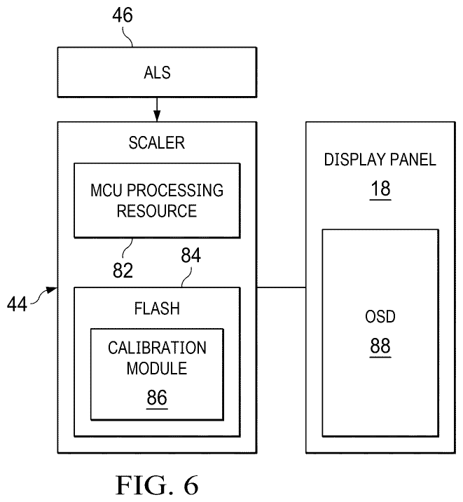

Referring now to FIG. 6, a block diagram depicts a display scaler 44 configured to calibrate display panel illumination. Scaler 44 receives as an input illumination measurements of ambient light sensor 46 and provides as an output commands to control presentation of visual images at display panel 18. Scaler 44 has a processing resource, such as an M CU processing resource 82 and a non-transitory memory, such as a flash memory 84, that stores instructions for execution on the processing resource. A calibration module 86 stored in the non-transitory memory includes instruction executed by the processing resource that present an OSD menu 88 to interface with an end user that allows selection of a display calibration. When display calibration is initiated, the instructions confirm that the calibration member is coupled in place to receive display illumination and direct the display illumination into the ambient light sensor 46, such as by comparing the visual images presented at the calibration location of the display panel with the light brightness and color temperature detected by the ambient light sensor. Once the placement of the calibration member is confirmed, the instructions present a set of color patterns that have defined red, green and blue illumination mixes. For instance, pattern [0,0,0] is black; pattern [124, 124, 124] is grey; pattern [255, 0, 0] is red; pattern [0, 0, 255] is blue; and pattern [96, 192, 192] is a light blue. As each color pattern is presented under the calibration member, the ambient light sensor reads the presented color. For the read color values, a chromatic adaption matrix is calculated from Ideal white to Measured white, such as by performing linear X Y Z scaling or similar conversion methods where [M_{R,G,B}]=[X_{Ideal}/X_{Measured}, Y_{Ideal}/Y_{Measured}, Z_{Ideal}/Z_{Measured}]. The adaption matrix is then applied to adjust visual images presented at the display. As an example, if the scaler has X Y Z stage in the video pipe, chromatic adaption is applied by multiplying M by the Old white. For a scaler that only has RGB processing in the video pipe, the old R, G, and B are multiplied by M. For a scaler without matrix multiplication block, the conversion M is applied as gain controls on RGB channels.

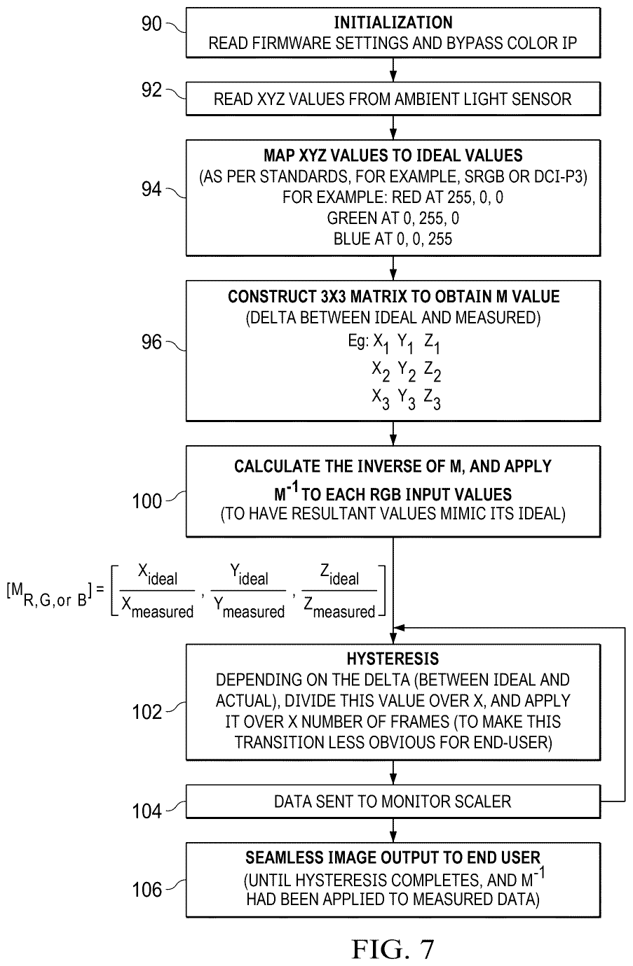

Referring now to FIG. 7, a flow diagram depicts a process for calibrating color values at a display panel. The process starts at step 90 with initialization of a color calibration logic that reads settings from firmware stored in non-transitory memory to bypass normal operational color settings and logic. At step 92 the X Y Z values for display panel color is read from the ambient light sensor. At step 94, the X Y Z values are mapped to ideal values as defined for the display panel, such as according to the SRGB or DCI-P3 standards that define red, blue and green colors between 0 and 255. At step 96, the mapped X Y Z values are applied to construct a 3×3 matrix that defines M values of the delta between ideal values and the measured values of the ambient light sensor. At step 100 an inverse of M is calculated and applied to each RGB input value at the display so that the display presents resultant values that mimic the ideal color values. At step 102 a hysteresis is applied based upon the size of the delta for the correction between ideal and actual color presentations to have a transition to the ideal color that is less obvious to an end user viewing the display. For instance, the delta value for each color is divided by an hysteresis factor X and applied as a correction over X number of frames. At step 104 the correction is sent to the scaler for application at the display panel over the X number of frames. At step 106, a seamless visual image color correction is completed to present an ideal color visual image to the end user.

Although the present invention has been described in detail, it should be understood that various changes, substitutions and alterations can be made hereto without departing from the spirit and scope of the invention as defined by the appended claims.

1. An information handling system comprising:
a housing;
a processor coupled in the housing and operable to execute instructions to process information;
a memory coupled in the housing and operable to store the instruction;
a display interfaced with the processor and operable to present the information as visual images at a display panel having an array of pixels, the display managing presentation of the visual images with a scaler having a processing resource and an ambient light sensor interfaced with the scaler to measure ambient light color and brightness; and
a calibration member having a first end aligned against the display panel and a second end aligned against the ambient light sensor to direct light from the display panel to the ambient light sensor for calibration of the display panel by the scaler.

2. The information handling system of claim 1 further comprising:
a non-transient memory interfaced with the scaler processing resource; and
instructions stored in the non-transient memory that when executed on the scaler processing resource causes:
measurement by the ambient light sensor of light directed from the display panel by the calibration member; and
comparison of the measurement against expected illumination presented by the display panel.

3. The information handling system of claim 2 wherein the instructions stored in the non-transient memory when executed on the scaler processing resource further cause:
presentation of an on-screen display menu at the display panel; and
selection of a display panel calibration operation through the on-screen display menu.

4. The information handling system of claim 2 wherein the instructions stored in the non-transient memory when executed on the scaler processing resource further cause:
detection of ambient light by the ambient light sensor within a predetermined illumination of a display illumination; and
in response to the detection, automated presentation of an on-screen display menu at the display panel to confirm a display panel calibration operation.

5. The information handling system of claim 2 wherein the instructions stored in the non-transient memory when executed on the scaler processing resource further cause:
determination of an adjustment to the display panel illumination to achieve a calibrated illumination; and
automated application of the adjustment.

6. The information handling system of claim 1 wherein the calibration member comprises a U-shaped body enclosing light guide material.

7. The information handling system of claim 6 wherein the light guide material comprises acrylic.

8. The information handling system of claim 6 further comprising:
a grill formed in an upper side of display proximate the ambient light sensor; and
members extending down from the U-shaped body aligned to engage in the grill to hold the calibration member to the display.

9. The information handling system of claim 8 wherein the members engage in the grill in a first orientation having the light guide material against the ambient light sensor and the display panel and a second orientation having the light guide material against the ambient light sensor and the display rear side.

10. A method for managing presentation of visual images at a display, the method comprising:
directing illumination from a display panel of the display to an ambient light sensor of the display with a light guide material;
measuring by the ambient light sensor of the illumination directed from the display panel by the light guide material; and
comparing of the measurement against expected illumination presented by the display panel to calibrate illumination of the display panel.

11. The method of claim 10 further comprising:
presenting of an on-screen display menu at the display panel; and
selecting of a display panel calibration operation through the on-screen display menu.

12. The method of claim 10 further comprising:
detecting of ambient light by the ambient light sensor within a predetermined illumination of a display panel illumination setting; and
in response to the detection, automatically presenting of an on-screen display menu at the display panel to confirm a display panel calibration operation.

13. The method of claim 10 further comprising:
determining of an adjustment to the display panel illumination to achieve a calibrated illumination; and
automatically applying of the adjustment to a setting of the display panel.

14. The method of claim 10 wherein the light guide material comprises acrylic enclosed in a body shaped to redirect the illumination 270 degrees.

15. The method of claim 14 further comprising inserting members extending from the body into a grill of the display to couple the body to the display.

16. A display comprising:
a display panel having an array of pixels operable to present visual images;
a scaler interfaced with the display panel and having a processing resource operable to execute instructions;
an ambient light sensor interfaced with the scaler to measure ambient light color and brightness; and
a calibration member having a first end aligned against the display panel and a second end aligned against the ambient light sensor to direct light from the display panel to the ambient light sensor for calibration of the display panel by the scaler.

17. The display of claim 16 further comprising:
a non-transient memory interfaced with the scaler processing resource; and
instructions stored in the non-transient memory that when executed on the scaler processing resource causes:
measurement by the ambient light sensor of light directed from the display panel by the calibration member; and
comparison of the measurement against expected illumination presented by the display panel.

18. The display of claim 17 wherein the instructions stored in the non-transient memory when executed on the scaler processing resource further cause:
detection of ambient light by the ambient light sensor within a predetermined illumination of a display illumination; and
in response to the detection, automated presentation of an on-screen display menu at the display panel to confirm a display panel calibration operation.

19. The display of claim 18 wherein the instructions stored in the non-transient memory when executed on the scaler processing resource further cause:
determination of an adjustment to the display panel illumination to achieve a calibrated illumination; and
automated application of the adjustment.

20. The display of claim 16 further comprising:
a grill formed in an upper side of the display proximate the ambient light sensor; and
members extending down from a U-shaped body and aligned to engage in the grill to hold the calibration member to the display with a light guide material optically interfacing the display panel and the ambient light sensor.
